(19) United States
(12) Patent Application Publication
(10) Pub. No.: US 2026/0277053 A1
(43) Pub. Date: Sep. 17, 2026

(54) DISPLAY DEVICE AND VEHICLE DETECTION SYSTEM INCLUDING SAME

(71) Applicant: AUO Corporation, Hsinchu City (TW)

(72) Inventor: Pang-Hsuan LIU, Hsinchu City (TW)

(21) Appl. No.: 19/396,564

(22) Filed: Nov. 21, 2025

(30) Foreign Application Priority Data
Mar. 14, 2025 (TW) 114109642

(51) Int. Cl. G02F 1/13357; B60R 11/02

(52) U.S. Cl. CPC G02F 1/1336; B60R 11/0235

(57) ABSTRACT

The present disclosure provides a display device and a vehicle detection system including the same. The display device includes a backlight module, a display panel, a frame, and a light source. The backlight module includes a circuit board and a plurality of light-emitting units arranged on the circuit board. The display panel has a light incident surface facing the backlight module. The frame is arranged on at least one side of the backlight module and at least partially supports the display panel. The frame has a side wall and a light guide portion that are adjacent to each other. The light guide portion includes a light incident end and a light emergence end. The light source is arranged adjacent to the light incident end and is configured to emit light. The light is guided into the light incident end and emitted from the light emergence end.

### CROSS REFERENCE TO RELATED APPLICATION

This application claims the priority benefit of Taiwan Patent Application No. 114109642, filed on March 14, 2025. The entirety of the mentioned above patent application is hereby incorporated by reference herein and made a part of this specification.

### BACKGROUND OF THE DISCLOSURE

### Field of the disclosure

The present disclosure relates to a display device and a vehicle detection system including the same. Specifically, the present disclosure relates to a display device having a frame and a light guide structure that are integrated, and a vehicle detection system including the same.

### Description of the Prior Art

With the development of technology, various types of devices that detect environmental conditions and/or user conditions and then provide assistance or suggestions have been widely used in various fields, for example, an on-board system. For example, in recent years, driver assistance systems have become standard equipment in automobiles, which may provide drivers with warnings and assisted handling in response to road conditions and emergencies. In addition to changes in an external environment, attention of the driver is also a factor affecting driving safety. A conventional driver monitoring system (DMS) may monitor a facial feature and a body movement of the driver through a camera, and provide a timely warning when detecting distraction of the driver. In addition, the development of autonomous driving systems has also made driving monitoring systems increasingly popular.

On the other hand, with the evolution of consumer electronics, the demand for various display products also increases. For example, in the on-board system, configuring a required display device such as a dashboard display, a DMS, and a reverse parking camera system in a limited space inside a vehicle, while pursuing a larger screen, a narrower bezel, and more diverse integrated functions, is the joint development goal of current on-board display products.

### SUMMARY OF THE DISCLOSURE

The present disclosure provides a display device, which integrates a frame and a light guide structure to achieve a purpose of improving space utilization efficiency.

The present disclosure also provides a vehicle detection system, which includes a camera and a display device having a frame and a light guide structure that are integrated, and is configured to detect a state of a user of a vehicle and achieve a purpose of simplifying a system space arrangement.

In an embodiment of the present disclosure, the display device includes a backlight module, a display panel, a frame, and a light source. The backlight module includes a circuit board and a plurality of light-emitting units arranged on the circuit board. The display panel has a light incident surface. The light incident surface faces the backlight module. The frame is arranged on at least one side of the backlight module and at least partially supports the display panel. The frame has a side wall and a light guide portion that are adjacent to each other. The light guide portion includes a light incident end and a light emergence end. The light source is arranged adjacent to the light incident end and is configured to emit light. The light is guided into the light incident end and emitted from the light emergence end.

In another embodiment of the present disclosure, the vehicle detection system includes the display device and a camera. The vehicle detection system is arranged in a vehicle, and the camera is arranged on a side of the display panel facing the backlight module.

### BRIEF DESCRIPTION OF THE DRAWINGS

FIG. 1 is a schematic three-dimensional view of a display device according to an embodiment.

FIG. 2 is a schematic exploded view of a display device according to an embodiment.

FIG. 3 is a partial schematic three-dimensional view of a display device according to an embodiment.

FIG. 4 is a partial front view of a display device according to an embodiment.

FIG. 5 is a top cross-sectional view of a display device according to an embodiment.

FIG. 6 is a side cross-sectional view of a display device according to an embodiment.

FIG. 7A and FIG. 7B are side cross-sectional views of display devices according to different embodiments.

FIG. 8 is a side cross-sectional view of a display device according to another embodiment.

FIG. 9A and FIG. 9B are schematic three-dimensional views of a bottom shell, a circuit board, and a light source according to different embodiments.

FIG. 10 is a side cross-sectional view of a display device according to still another embodiment.

FIG. 11A and FIG. 11B are side cross-sectional views of vehicle detection systems according to different embodiments. FIG. 11C is a schematic diagram of a vehicle detection system arranged in a vehicle according to an embodiment.

### DETAILED DESCRIPTION OF THE DISCLOSURE

Various embodiments are to be described below, and a person with ordinary knowledge in the technical field can easily understand the spirit and principles of the present disclosure by referring to the accompanying drawings. However, although some specific embodiments are to be specifically described herein, these embodiments are only illustrative and are not to be considered restrictive or exhaustive in all aspects. Therefore, various changes and modifications of the present disclosure should be obvious and easily implemented for a person with ordinary knowledge in the technical field without departing from the spirit and principles of the present disclosure.

In the accompanying drawings, for clarity, thicknesses of a layer, a film, a panel, a region, and the like are enlarged. Throughout the specification, same reference numerals represent same elements. It should be understood that when an element such as a layer, a film, a region, or a substrate is referred to as being "on" or "connected to" another element, the element may be directly on or connected to the another element, or an intermediate element may also be present. On the contrary, when an element is referred to as being "directly on another element" or "directly connected to" another element, no intermediate element exists. As used herein, a "connection" may mean a physical connection and/or an electrical connection.

It should be understood that although the terms "first", "second", "third", and the like may be used herein to describe various elements, components, regions, layers, and/or parts, these elements, components, regions, and/or parts should not be limited by these terms. These terms are only used to distinguish one element, component, region, layer, or part from another element, component, region, layer, or part. Therefore, the "first element", "first component", "first region", "first layer", or "first part" discussed below may be referred to as a second element, component, region, layer, or part without departing from the teachings herein.

The terms used herein are for the purpose of describing particular embodiments only and are not intended to be limiting. As used herein, unless the context clearly indicates otherwise, singular forms "a", "an", and "the" are intended to include plural forms, including "at least one". "Or" represents "and/or". As used herein, the term "and/or" includes any or all combinations of one or more related listed items. It should be further understood that when used in this specification, the term "comprise" and/or "include" specifies the presence or addition of the feature, region, entirety, step, operation, element, and/or component, but does not exclude the presence or addition of one or more other features, regions, entireties, steps, operations, elements, components, and/or combinations thereof.

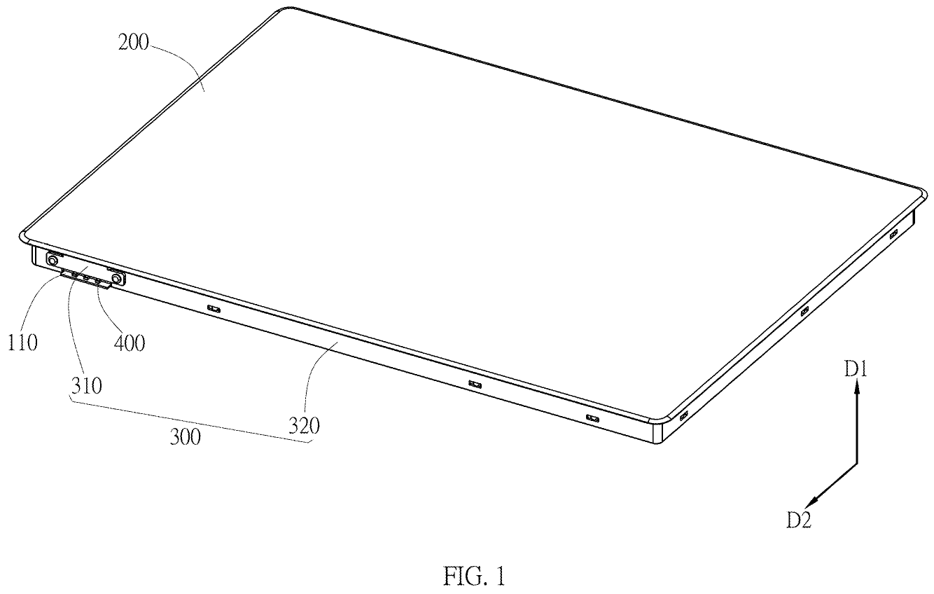

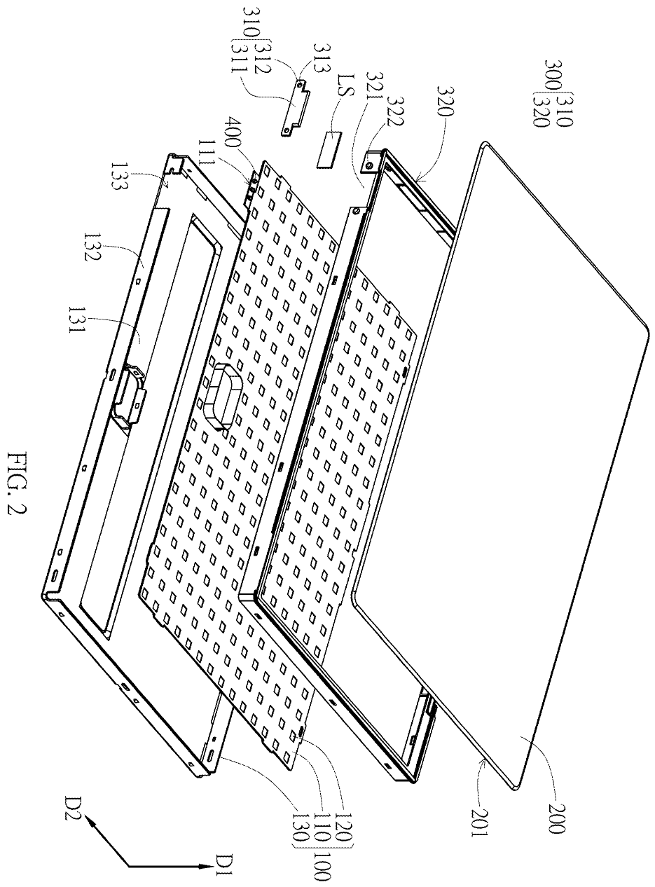

As shown in FIG. 1 and FIG. 2, in an embodiment, a display device includes a backlight module 100, a display panel 200, a frame 300, and a light source 400. In this embodiment, the backlight module 100 may be designed as a direct-type light source and includes a circuit board 110 and a plurality of light-emitting units 120 arranged on the circuit board 110. The light-emitting units 120 may be arranged in a checkerboard pattern on the circuit board 110 as shown in FIG. 2, or may be arranged in a different manner in another embodiment, for example, distributed close to an edge of the display device (not shown). The light-emitting unit 120 may include a cold cathode fluorescent lamp (CCFL), a light-emitting diode (LED), an organic light-emitting diode (OLED), electroluminescence elements, and the like. The light-emitting unit 120 may be designed to emit white light or light of other wavelength ranges, which is not limited thereto. Based on different designs and applications, the backlight module 100 may further include optical components (not shown) such as a light diffusion plate and a prism, to adjust the light emitted by the light-emitting unit 120. The display panel 200 has a light incident surface 201. The light incident surface 201 faces the backlight module 100 to receive the light emitted by the light-emitting unit 120. A direction in which the backlight module 100 and the display panel 200 are stacked is defined as a first direction D1. Specifically, the display panel may include a liquid crystal display but is not limited thereto.

The frame 300 may be arranged on at least one side of the backlight module 100 and at least partially supports the display panel 200. In the embodiments shown in FIG. 1 and FIG. 2, the frame 300 may be a rectangular frame and may support an edge of the display panel 200. In another embodiment, the frame 300 may also have different shapes, including but not limited to a long strip or a bent angle shape. The frame 300 may form a closed square ring or adopt a non-closed design. In addition, the backlight module 100 may further include a bottom shell 130 arranged on a side of the backlight module 100 away from the display panel 200. The circuit board 110 of the backlight module 100 may be arranged on the bottom shell 130. The bottom shell 130 may be adjacent to the frame 300 and may also partially support the frame 300 and/or support the display panel 200 together with the frame 300.

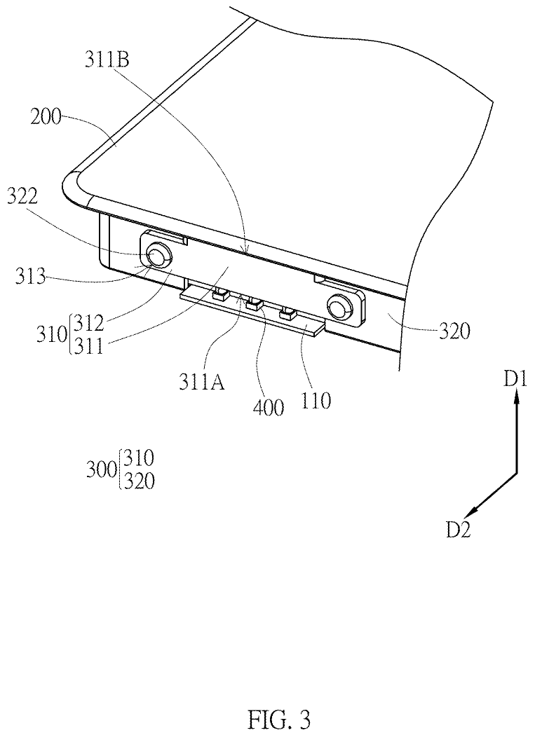

Further, the frame 300 may have a side wall 320 and a light guide portion 310 that are adjacent to each other. In an embodiment, as shown in FIG. 2 and FIG. 3, a notch 321 is formed on the side wall 320. The light guide portion 310 is at least partially arranged in the notch 321. The side wall 320 and the light guide portion 310 may include different materials. The light guide portion 310 may be embedded in the notch 321 of the side wall 320 in different connection manners. For example, in the embodiments shown in FIG. 3 to FIG. 5, the side wall 320 includes a bump 322. The bump 322 is arranged adjacent to the notch 321. The light guide portion 310 includes a body 311 and a side portion 312 located on at least one side (for example, two sides) of the body 311. The side portion 312 has a through hole 313. The bump 322 passes through the through hole 313 to position the side wall 320 and the light guide portion 310. Specifically, during assembling of the frame 300, the body 311 of the light guide portion 310 may be positioned in the notch 321 of the frame 300, and the bump 322 of the side wall 320 passes through the through hole 313 on the side portion 312. Then the hot-melt bump 322 protrudes from an end of the light guide portion 310, so that the end of the bump 322 is deformed to such an extent that it cannot pass through the through hole 313. For example, a width of the end of the bump 322 is greater than a width of the through hole 313, so as to prevent the light guide portion 310 from detaching from the side wall 320. Alternatively, the side wall 320 may also be bonded to the light guide portion 310. For example, an adhesive is applied between the side wall 320 and the light guide portion 310, or an adhesive tape is attached to outer sides of the side wall 320 and the light guide portion 310 (that is, facing outside of the display device). In addition, the side wall 320 and the light guide portion 310 may also be integrally formed and include different materials. For example, the side wall 320 and the light guide portion 310 that are adjacent to each other are formed through a double injection technology. Through the foregoing arrangement, a thickness of the frame including the light guide portion may be reduced, thereby improving aesthetics and space utilization efficiency of the display device.

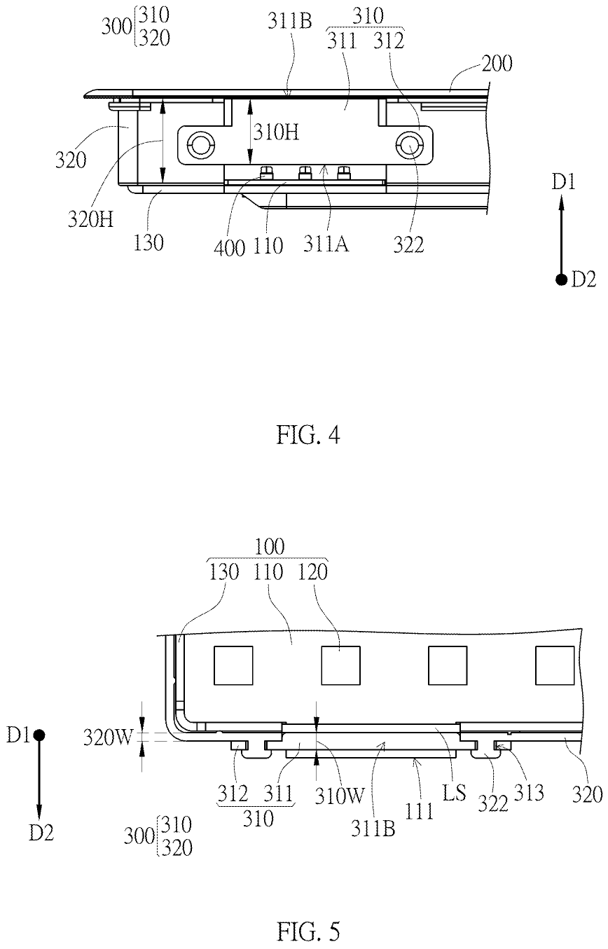

As shown in FIG. 3 and FIG. 4, the light guide portion 310 may include a light incident end 311A and a light emergence end 311B. An extending direction of the light incident end 311A pointing to the light emergence end 311B may pass through a plane where the display panel 200 is located, for example, along a first direction D1, which is not limited thereto. A light source 400 may be arranged adjacent to the light incident end 311A and configured to emit light. The light is guided into the light incident end 311A and emitted from the light emergence end 311B. The light emergence end 311B may face the display panel 200 or an upper cover plate, so that the light passes through the display panel 200 or the upper cover plate, which is not limited thereto.

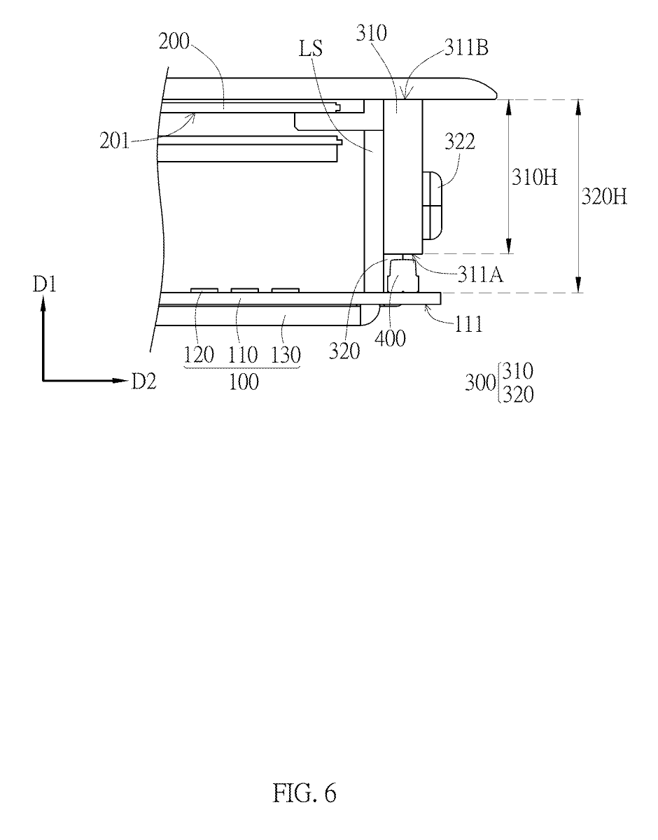

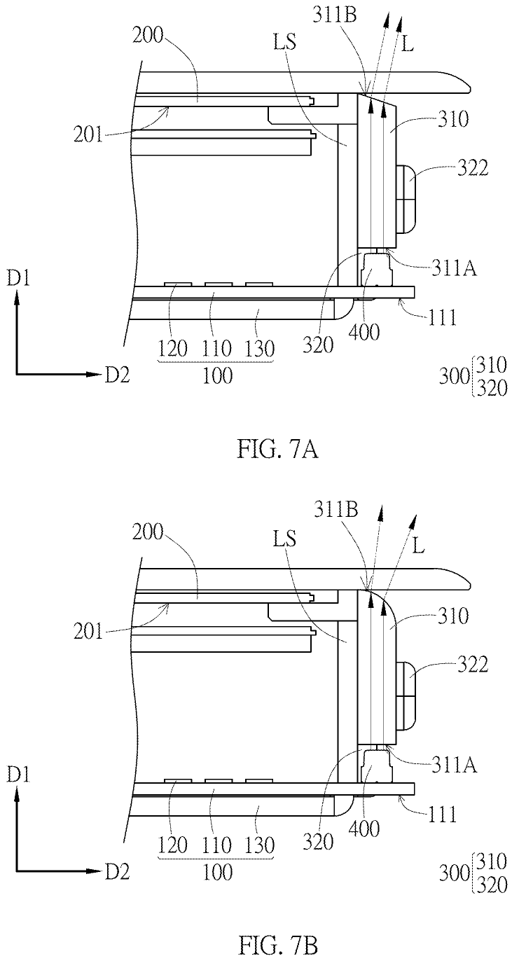

In some embodiments, the light source 400 may be arranged on the circuit board 110 of the backlight module 100, as shown in FIG. 2 to FIG. 4. Moreover, as shown in FIG. 5, a thickness 310W of a light guide portion 310 may be greater than a thickness 320W of a side wall 320 in a direction parallel to a plane where a display panel 200 is located and perpendicular to an extending direction of a frame 300, for example, in a second direction D2, so that an end surface of a light incident end 311A of the light guide portion 310 can completely cover a light-emitting surface of a light source 400. In addition, as shown in FIG. 6 (also see FIG. 4), in an extending direction of a light incident end 311A of a light guide portion 310 pointing to a light emergence end 311B, for example, in a first direction D1, a height 310H of the light guide portion 310 may be less than a height 320H of a side wall 320, so as to have a sufficient space to accommodate a light source 400.

Based on different designs and applications, the light source 400 may be designed to emit light of different wavelengths, including white light, visible light of different wavelengths, or invisible light such as infrared light. Corresponding to a light-emitting wavelength of the light source 400, a material for the light guide portion 310 may be made of a material having high transmittance within the wavelength range. For example, in an embodiment where the light source 400 emits infrared light, the light guide portion 310 may include a material with high infrared light transmittance such as polycarbonate (PC) or poly(methyl methacrylate) (PMMA), for example, having a transmittance of more than 80% within a wavelength range of 850 nanometers to 1100 nanometers. In addition, the light guide portion 310 may further include a dye that is permeable to infrared light but difficult to permeate to visible light (for example, the permeability is less than 5% within a wavelength range of 400 nanometers to 700 nanometers), so as to prevent light emitted by a backlight module 100 from leaking through the light guide portion 310. On the other hand, as shown in FIG. 5 and FIG. 6, the display device may further have a light blocking material LS, which is a material that is difficult for light within a specific wavelength range to penetrate, for example, a non-transparent thin plate or an adhesive tape. The light blocking material LS may be arranged on a side of the light guide portion 310 facing an interior of the backlight module 100, for example, a side facing the light-emitting unit 120, or alternatively arranged on an opposite side of the light guide portion 310, that is, facing outside of the display device (not shown), so as to block the light emitted by the backlight module 100 from leaking through an unexpected position. The foregoing adhesive tape can not only block light from transmitting, but also may have a fixing function of bonding the light guide portion 310 and the side wall 320.

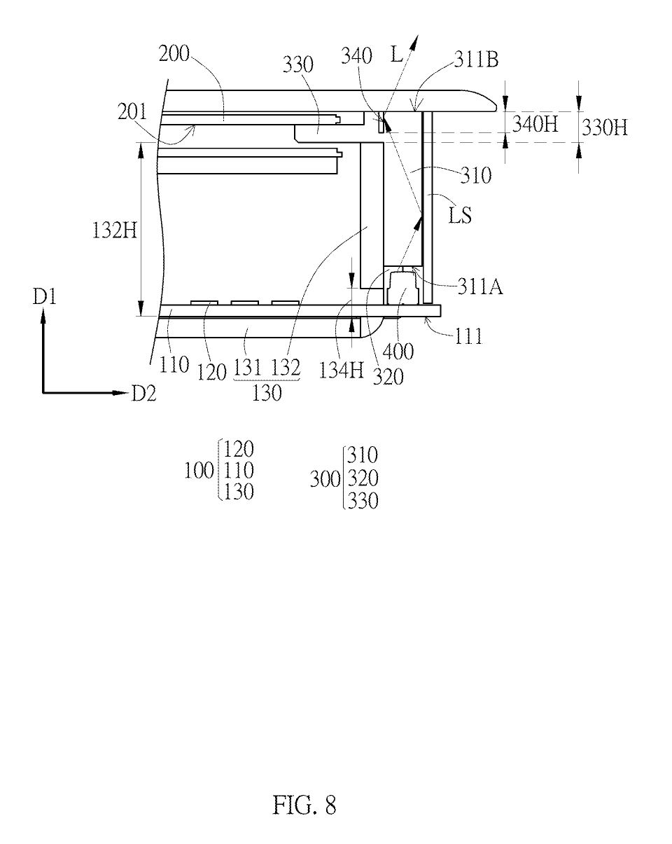

As shown in FIG. 6, in some embodiments, the light emergence end 311B of the light guide portion 310 may be located on a plane parallel to a plane where a display panel 200 is located, so that the light emitted by the light source 400 propagates substantially in a direction perpendicular to the display panel 200 (that is, a first direction D1). In some other embodiments, the light emergence end 311B of the light guide portion 310 may have a light path adjustment structure to change a direction of the light leaving the light emergence end 311B. As shown in FIG. 7A, a light path adjustment structure of a light emergence end 311B may include an inclined surface, which may be inclined relative to a plane where a display panel 200 is located, so that a propagation direction of the light L passing through the inclined surface deviates from a first direction D1 and is inclined in a direction away from a center of the display panel 200. Further, as shown in FIG. 7B, a light path adjustment structure may include an arc surface, which protrudes outward relative to a light guide portion 310. A height of the light guide portion 310 in a first direction D1 gradually decreases as the light guide portion moves away from a center of a display panel 200, so that a propagation direction of the light L passing through the arc surface may gradually deviate outward from the first direction D1, and an angular distribution range of the light L is increased. Through this arrangement, the light emitted from a light source 400 may be projected to a desired location in response to different needs.

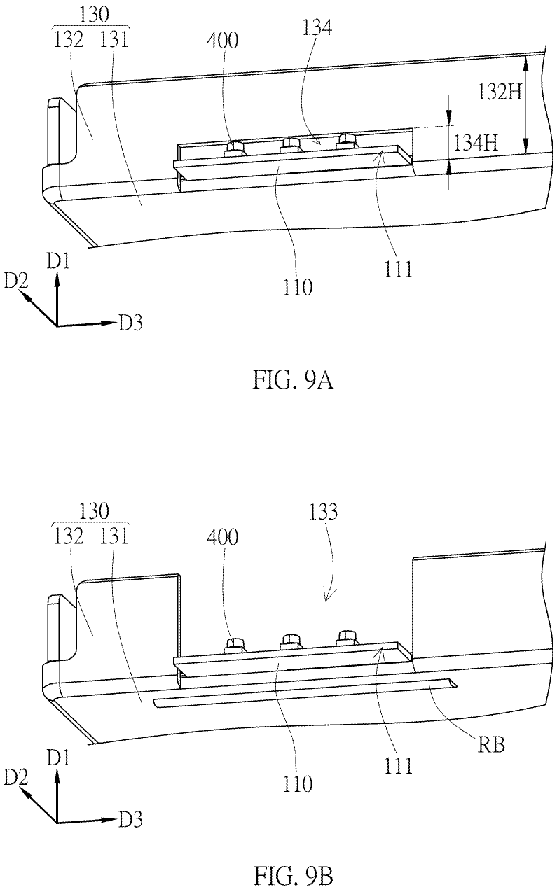

In another embodiment, as shown in FIG. 8, a side wall 320 and a light guide portion 310 may be integrally formed and include the same material. A frame 300 may further include a flange 330 which is located on a side of the light guide portion 310 facing an interior of a backlight module 100. The flange 330 at least partially supports a display panel 200. Through the arrangement of the flange 330, structural strength of the frame 300 may be increased, and assembly of the display device is facilitated. In an embodiment in which the flange 330 and the light guide portion 310 are made of the same material, a cut groove 340 may be provided between the light guide portion 310 and the flange 330 to reduce a proportion of light emitted by the light source 400 entering the flange 330, so that the light are mainly emitted from the light emergence end 311B. Specifically, in a direction passing through a plane where the display panel 200 is located, for example, in a first direction D1, a depth 340H of the cut groove 340 may be less than a height 330H of the flange 330. To be specific, the cut groove 340 does not penetrate the flange 330 to maintain structural strength. In an embodiment where the flange 330 includes a material that is difficult for the light within a specific wavelength range to penetrate, this arrangement may also block light from the backlight module 100 from passing through the flange 330. On the other hand, in an embodiment in which a side wall 320 and a light guide portion 310 include a material that is transparent to visible light, a light blocking material LS may be provided on an outer side thereof (that is, a side away from an interior of the backlight module 100), to prevent visible light emitted from the backlight module 100 from being transmitted.

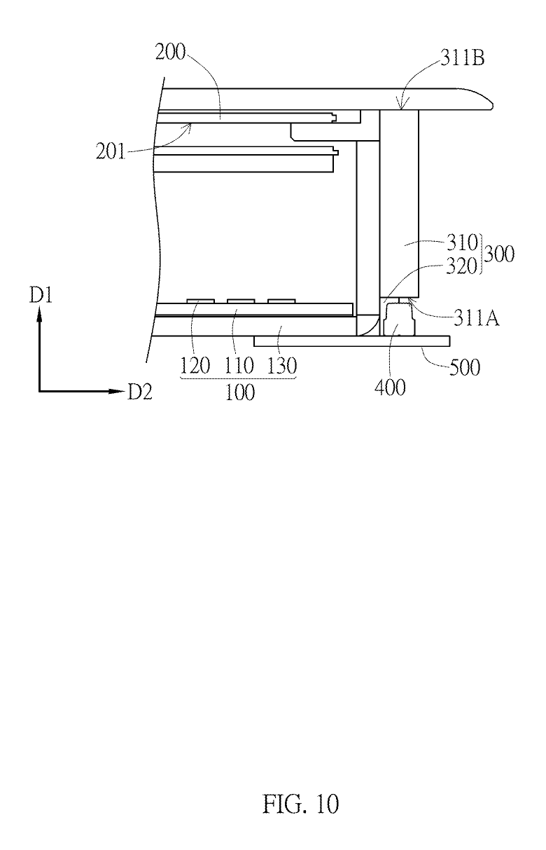

As described above and referring to FIG. 2 to FIG. 6, the backlight module 100 may include a bottom shell 130. The circuit board 110 may be arranged on the bottom shell 130. FIG. 9A and FIG. 9B show designs of bottom shells 130 in different embodiments. To clearly present a relative relationship of elements, FIG. 9A and FIG. 9B show only a bottom shell 130, a circuit board 110, and a light source 400 in a display device, and other elements are omitted. In an embodiment, as shown in FIG. 9A, the bottom shell 130 may include a back plate 131 and a side plate 132 that are adjacent to each other. The side plate 132 is adjacent to a frame 300 and has a slot 134 close to the back plate 131. The circuit board 110 may include a protruding end 111 extending out of the slot 134. The light source 400 may be arranged on the protruding end 111. Referring to FIG. 8 as well, in a direction passing through a plane where a display panel 200 is located, that is, in a first direction D1, a height 134H of the slot 134 may be less than a height 132H of a side plate 132, so that a part of the side plate 132 is located between the slot 134 and the display panel 200. In another embodiment, as shown in FIG. 9B, alternatively, a side plate 132 may have an opening 133 close to a back plate 131. A protruding end 111 of a circuit board 110 may extend beyond the back plate 131 and extend out of the opening 133. A height of the opening 133 in a first direction D1 is equal to a height of the side plate 132. To be specific, the opening 133 extends from an end of the side plate 132 close to the back plate 131 to an opposite end. In this embodiment, the back plate 131 may further have a reinforcing portion RB, which protrudes from the back plate 131 and is close to the opening 133. The reinforcing portion RB may be, for example, a long strip structure protruding in a direction away from the circuit board 110. In an extending direction of the side plate 132 (that is, a third direction D3), a width of the reinforcing portion RB may be greater than a width of the opening 133, to strengthen structural strength of the bottom shell 130. Through the foregoing configuration, the light source 400 and the backlight module 100 may share a circuit board, to simplify space configuration and save costs.

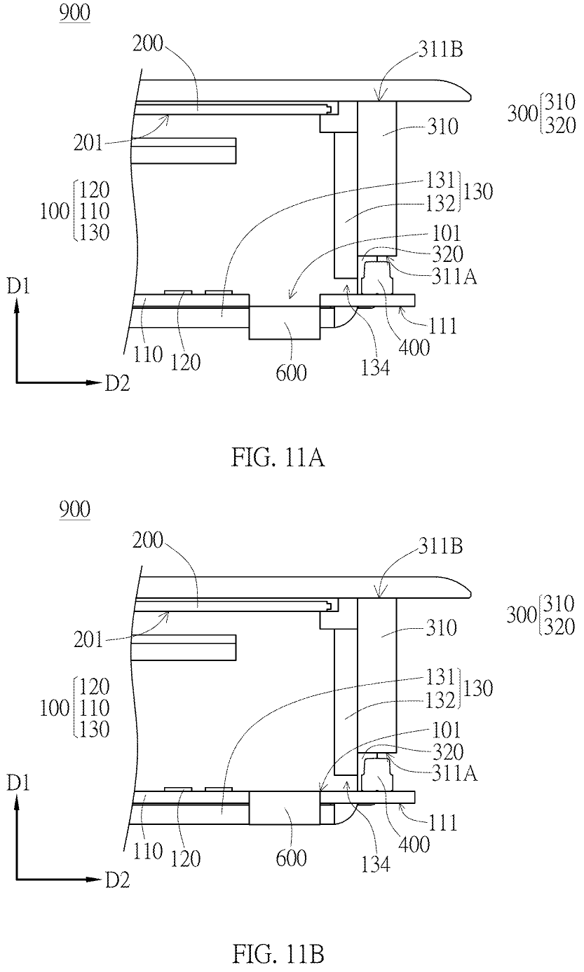

In different embodiments, the light source 400 may also be arranged on an additional circuit board. As shown in FIG. 10, a display device may further include a light source circuit board 500. A backlight module 100 may include a bottom shell 130. The bottom shell 130 is arranged on a side of the backlight module 100 away from a display panel 200 and is adjacent to a frame 300. A light source circuit board 500 may be arranged to at least partially overlap with the bottom shell 130 and close to a light incident end 311A of a light guide portion 310, and a light source 400 may be arranged on the light source circuit board 500. In other words, the light source circuit board 500 and the circuit board 110 of the backlight module 100 may be respectively located on two opposite sides of the bottom shell 130.

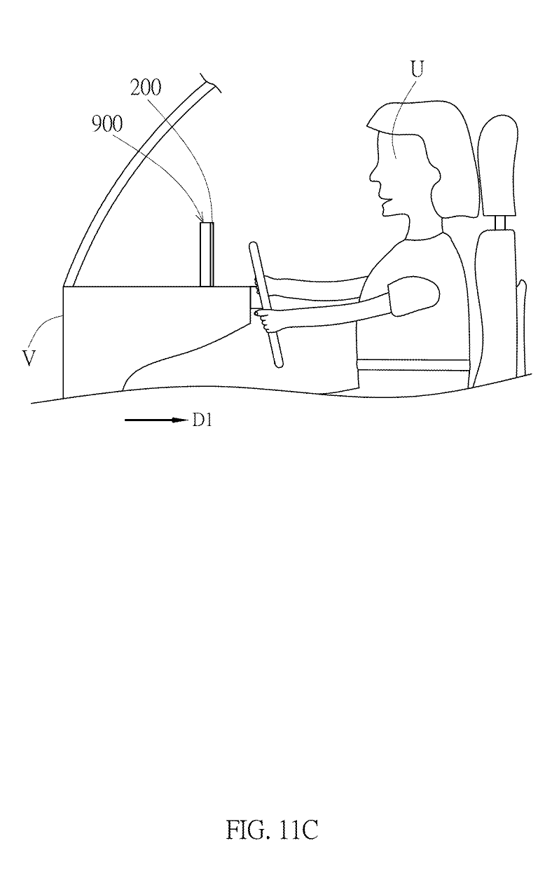

The present disclosure also provides a vehicle detection system, including the display device described in the foregoing embodiments and a camera. The camera may be arranged on a side of a display panel facing a backlight module. As shown in the embodiments of FIG. 11A to FIG. 11C, a vehicle detection system 900 may be arranged in a vehicle V. A camera 600 may be arranged on a side of a backlight module 100 away from a display panel 200. The backlight module 100 is provided with a corresponding opening 101 (as shown in FIG. 11A), or the camera 600 may also be embedded in the backlight module 100 through the opening 101 of the backlight module 100 (as shown in FIG. 11B), which is not limited thereto. The camera 600 may include, but is not limited to, an under- display camera (UDC), which may capture an image of an interior of the vehicle toward a light incident surface 201 of the display panel 200. In an embodiment, as shown in FIG. 11C, a vehicle detection system 900 may be arranged in a vehicle V that needs to be operated by a user U to detect a facial feature and a body movement of the user U, thereby analyzing an operating state of the user U. The vehicle V may include an automobile or another transportation device. In addition, a light source in the display device may be designed to emit light of a specific wavelength. The camera 600 may receive a corresponding wavelength range of the light emitted by the light source 400. For example, the light source 400 may emit infrared rays to detect facial features of a user, to avoid affecting a line of sight of the user and reduce interference from ambient illumination, which is not limited thereto. On the other hand, the vehicle detection system may include the light path adjustment structure described above (see FIG. 7A and FIG. 7B), to direct the light emitted by the light source 400 to an area to be detected in the vehicle, for example, a location of a user and/or another passenger. In different embodiments, the vehicle detection system may further integrate other functions to assist user operations, for example, sound warnings, visual warnings, and vehicle exterior environment detection, to improve convenience and safety of operating the vehicle.

The above descriptions are merely some preferred embodiments of the present disclosure. It should be noted that various changes and modifications can be made to the present disclosure without departing from the spirit and principles of the present disclosure. A person of ordinary skill in the art should clearly understand that the present disclosure is defined by the appended patent application scope, and in accordance with the spirit of the present disclosure, various possible changes such as substitutions, combinations, modifications, and diversions are within the scope of the present disclosure as defined by the appended patent application scope.

What is claimed is:

1. A display device comprising:
a backlight module including a circuit board and a plurality of light-emitting units arranged on the circuit board;
a display panel having a light incident surface, wherein the light incident surface faces the backlight module;
a frame arranged on at least one side of the backlight module and at least partially supporting the display panel, wherein the frame has a side wall and a light guide portion that are adjacent to each other, and the light guide portion includes a light incident end and a light emergence end; and
a light source arranged adjacent to the light incident end and configured to emit light, wherein the light is guided into the light incident end and emitted from the light emergence end.

2. The display device according to claim 1, wherein the side wall and the light guide portion comprise different materials.

3. The display device according to claim 2, further comprising a light blocking material, wherein the light blocking material is arranged on a side of the light guide portion facing an interior of the backlight module.

4. The display device according to claim 2, wherein the side wall has a notch, and the light guide portion is arranged in the notch.

5. The display device according to claim 4, wherein the side wall includes a bump, the bump is adjacent to the notch, the light guide portion includes a body and a side portion located on a side of the body, the side portion has a through hole, and the bump passes through the through hole to fix the side wall and the light guide portion.

6. The display device according to claim 4, wherein the side wall is bonded to the light guide portion.

7. The display device according to claim 1, wherein the side wall and the light guide portion are integrally formed, and the side wall and the light guide portion comprise the same material.

8. The display device according to claim 7, wherein the frame further includes a flange, the flange is located on a side of the light guide portion facing an interior of the backlight module, a cut groove is provided between the light guide portion and the flange, and the flange at least partially supports the display panel.

9. The display device according to claim 8, wherein a depth of the cut groove is less than a height of the flange in a direction passing through a plane where the display panel is located.

10. The display device according to claim 1, further comprising a light blocking material, wherein the light blocking material is arranged on a side of the light guide portion away from an interior of the backlight module.

11. The display device according to claim 1, wherein an extending direction of the light incident end of the light guide portion pointing to the light emergence end passes through a plane where the display panel is located.

12. The display device according to claim 1, wherein in a direction parallel to a plane where the display panel is located and perpendicular to an extending direction of the frame, and a thickness of the light guide portion is greater than a thickness of the side wall.

13. The display device according to claim 1, wherein in an extending direction of the light incident end of the light guide portion pointing to the light emergence end, and a height of the light guide portion is less than a height of the side wall.

14. The display device according to claim 1, wherein the light emergence end of the light guide portion has a light path adjustment structure.

15. The display device according to claim 14, wherein the light path adjustment structure includes an inclined surface, and the inclined surface is inclined relative to a plane where the display panel is located.

16. The display device according to claim 14, wherein the light path adjustment structure includes an arc surface, and the arc surface protrudes outward relative to the light guide portion.

17. The display device according to claim 1, further comprising a light source circuit board, wherein the backlight module further includes a bottom shell, the bottom shell is arranged on a side of the backlight module away from the display panel and is adjacent to the frame, the light source circuit board is arranged to at least partially overlap with the bottom shell and close to the light incident end of the light guide portion, and the light source is arranged on the light source circuit board.

18. The display device according to claim 1, wherein the backlight module further includes a bottom shell, the bottom shell includes a back plate and a side plate that are adjacent to each other, the side plate is adjacent to the frame and has a slot close to the back plate, the circuit board is arranged on the back plate and includes a protruding end extending out of the slot, and the light source is arranged on the protruding end, and
in a direction passing through a plane where the display panel is located, a height of the slot is less than a height of the side plate.

19. The display device according to claim 1, wherein the backlight module further includes a bottom shell, the bottom shell includes a back plate and a side plate that are adjacent to each other, the side plate is adjacent to the frame and has an opening close to the back plate, the circuit board is arranged on the back plate and includes a protruding end extending out of the opening, and the light source is arranged on the protruding end;
in a direction passing through a plane where the display panel is located, a height of the opening is equal to a height of the side plate; and
the back plate is provided with a reinforcing portion, and the reinforcing portion protrudes from the back plate and is close to the opening.

20. A vehicle detection system comprising the display device according to claim 1 and a camera, wherein the vehicle detection system is arranged in a vehicle, and the camera is arranged on a side of the display panel facing the backlight module.
